(19) United States
(12) Patent Application Publication
(10) Pub. No.: US 2019/0188494 A1
(43) Pub. Date: Jun. 20, 2019

(54) VEHICLE DRIVING ASSIST DEVICE, INSTRUCTION DISPLAY DEVICE AND VEHICLE LAMP

(71) Applicant: KOITO MANUFACTURING CO., LTD., Tokyo (JP)

(72) Inventors: Yoshinori Sawa, Shizuoka (JP); Yuichi Watano, Shizuoka (JP)

(73) Assignee: KOITO MANUFACTURING CO., LTD., Tokyo (JP)

(21) Appl. No.: 16/225,060

(22) Filed: Dec. 19, 2018

(30) Foreign Application Priority Data
Dec. 19, 2017 (JP) 2017-242280

(51) Int. Cl. G06K 9/00; F21S 43/00; B60Q 1/30; H04B 10/114; G08G 1/16

(52) U.S. Cl. CPC G06K 9/00791; F21S 43/00; G08G 1/16; H04B 10/114; B60Q 1/30

(57) ABSTRACT

A vehicle driving assist device which is mounted on a vehicle, includes an instruction recognition device which is configured to recognize operation instruction information for a vehicle displayed on a road surface. The vehicle on which the vehicle driving assist device is mounted is operated based on the operation instruction information. An instruction display device is mounted on a vehicle and is configured to display operation instruction information for another vehicle on a road surface with near-infrared light.

### CROSS-REFERENCE TO RELATED APPLICATIONS

The present application claims priority from Japanese Patent Application No. 2017-242280, filed Dec. 19, 2017, the entire content of which is incorporated herein by reference.

### TECHNICAL FIELD

Aspects of the present invention relate to a vehicle driving assist device, an instruction display device and a vehicle lamp which automatically assist following driving based on instruction information while following a transmission source of the instruction information.

### BACKGROUND ART

JP-A-2016-60314 (FIGS. 1 and 2 and Paragraphs [0025] to [0028]) discloses a preceding vehicle detection system in which a near-infrared LED light source is provided in a sub-tail lamp of a preceding vehicle to generate invisible bright spots, which are detected by an imaging device of a following vehicle, and thus the preceding vehicle can be accurately detected. Further, JP-A-2015-225558 (first embodiment ([0024]) and FIGS. 1 and 4) discloses a vehicle-to-vehicle communication system in which a data frame including an own vehicle ID and own vehicle information is transmitted and received between a plurality of vehicles both in optical communication and DSRC wireless communication, and both the communication IDs are compared to determine a preceding vehicle, so that erroneous detection of the preceding vehicle is prevented.

In the preceding vehicle detection system of JP-A-2016-60314, erroneous recognition of the preceding vehicle which is a transmission source is reduced by marking the bright spots emitted from the preceding vehicle with near-infrared LED light. However, only the presence or absence of the preceding vehicle can be detected since the detected light is bright spots.

Further, in the vehicle-to-vehicle communication system of JP-A-2015-225558, detailed automatic driving assist control based on the received communication information becomes possible without erroneously determining the vehicle which is the transmission source, but an automatic driving assist system is expensive and cannot be easily realized since both optical communication and wireless communication systems and a complicated information analysis device are required.

### SUMMARY

Accordingly, an aspect of the present invention provides a simple vehicle driving assist device, an instruction display device, and a vehicle lamp which can realize automatic following driving based on instruction information while easily determining a transmission source of the instruction information.

According to an embodiment of the present invention, there is provided a vehicle driving assist device which is mounted on a vehicle and includes an instruction recognition device which is configured to recognize operation instruction information for a vehicle displayed on a road surface, and the vehicle on which the vehicle driving assist device is mounted is operated based on the operation instruction information.

According to the above configuration, the instruction recognition device of the vehicle limitedly recognizes the operation instruction information for the vehicle displayed on the road surface obliquely below the vehicle, and the vehicle driving assist device automatically operates the vehicle based on instruction in the operation instruction information.

According to another embodiment of the present invention, there is provided an instruction display device which is configured to display operation instruction information for another vehicle on a road surface with near-infrared light.

According to the above configuration, the instruction display device displays the operation instruction information for another vehicle by near-infrared light limitedly on the road surface obliquely below the vehicle on which the instruction display device is mounted.

In the instruction display device, the operation instruction information may be displayed on the road surface between the vehicle and another vehicle which includes a driving assist device having an instruction recognition device configured to recognize operation instruction information.

According to the above configuration, the instruction display device provided in the vehicle displays the operation instruction information of the vehicle with invisible light on the road surface limited between the vehicle and another vehicle which includes the driving assist device having the instruction recognition device configured to recognize the operation instruction information, and thus the another vehicle automatically operates based on the instruction information of the vehicle on which the instruction display device serving as a transmission source is mounted.

Further, the instruction display device may be mounted on the vehicle which includes the driving assist device having an instruction recognition device configured to recognize the operation instruction information.

According to the above configuration, the instruction display device is further mounted on a following vehicle which follows a preceding vehicle by the driving assist device, displays operation instruction information for another following vehicle including the driving assist device on a road surface.

In the vehicle driving assist device, the instruction information may be a graphic indication formed on the road surface in advance.

According to the above configuration, the instruction recognition device recognizes instruction information from an indication which is formed in advance as a line, symbol, character, figure, pattern, or the like by a stud, paint, stone or the like on the road surface in the vicinity of the vehicle, and the driving assist device automatically operates the vehicle based on the recognized instruction information.

According to a further embodiment of the present invention, there is provided a vehicle lamp including the above vehicle driving assist device.

The instruction recognition device of the vehicle lamp recognizes the instruction information which is related to the vehicle and is displayed limitedly on the road surface in a vicinity of the vehicle, and the vehicle driving assist device automatically operates the vehicle based on an instruction in the operation instruction information.

According to a still further embodiment of the present invention, there is provided a vehicle lamp including the above instruction display device.

According to the above configuration, the instruction display device of the vehicle lamp displays operation instruction information on operation for a following vehicle by near-infrared light limitedly on the road surface in the vicinity of the vehicle on which the instruction display device is mounted.

According to the above vehicle driving assist device, the operation instruction information for the vehicle indicated on the road surface obliquely below the vehicle periphery is recognized by the instruction recognition device, the recognition area of the instruction information is limited to the periphery of the vehicle on which the driving assist device is mounted, and instruction information of the vehicle away from the vehicle on which the driving assist device is mounted cannot be recognized, so that the transmission source of the instruction information can be easily determined and the automatic following driving based on the recognized instruction information can be easily realized even though no complicated device is provided.

According to the above instruction display device, the display area of the operation instruction information of another vehicle by near-infrared light is limited on the road surface around the vehicle on which the instruction display device is mounted, and only operation instruction information of another predetermined vehicle which is approaching the vehicle on which the instruction display device is mounted and includes the driving assist device with the instruction recognition device can be recognized, so that the transmission source of the operation instruction information can be easily determined and the automatic following driving based on the recognized operation instruction information can be easily realized.

According to the instruction display device, since the display area of the instruction information from the vehicle on which the instruction display device is mounted is limited to the road surface between the preceding vehicle and the following vehicle, the vehicle on which the instruction display device which is the transmission source of the instruction information is mounted is simply determined by the vehicle on which the driving assist device is mounted, and the automatic following driving of the following vehicle with respect to the preceding vehicle and operation instruction information communication between the preceding vehicle and the following vehicle can be easily realized. In addition, by using invisible light, information on the automatic following driving can be exchanged between vehicles without giving unnecessary information to a driver of a vehicle, a pedestrian, or the like.

According to the instruction display device, the display area of the operation instruction information from the following vehicle which follows a predetermined preceding vehicle is limited to the road surface between the following vehicle and another following vehicle including the driving assist device having the instruction recognition device, and the operation instruction information can be recognized only by the another following vehicle, so that the automatic following driving in which a plurality of vehicles follow in series can be easily realized.

According to the vehicle driving assist device, since the instruction recognition device recognizes the operation instruction information based on a paint pattern or the like formed on the road in advance and the vehicle on which the driving assist device is mounted automatically operates based on the instruction information, accurate automatic following driving can be easily realized.

According to the vehicle lamp, the recognition area of the operation instruction information of the vehicle by the instruction recognition device is limited to the vicinity of the vehicle on which the vehicle lamp is mounted, so that the transmission source of the instruction information can be easily determined and the automatic following driving based on the recognized instruction information can be easily realized even if there is no complicated device.

According to the vehicle lamp, the display area of the instruction information on the operation of the following vehicle is limited to the road surface in the vicinity of the vehicle on which the instruction display device is mounted, and the following vehicle including the driving assist device capable of recognizing the operation instruction information is only limited to the vehicle approaching the vehicle on which the vehicle lamp is mounted, so that the transmission source of the operation instruction information can be easily determined and the automatic following driving based on the recognized operation instruction information can be easily realized.

### BRIEF DESCRIPTION OF DRAWINGS

FIG. 1 is a conceptual diagram illustrating a driving assist device and an instruction display device according to an embodiment, FIG. 1A is a conceptual diagram in which a vehicle including a driving assist device and a vehicle including an instruction display device are exchanged.

FIG. 2A is a front view of a first vehicle including a driving assist device, and FIG. 2B shows a block diagram of the driving assist device.

FIG. 3A is a rear view of a second vehicle including an instruction display device, FIG. 3B is a cross-sectional view taken along IIIB-IIIB of FIG. 3A and showing the instruction display device, and FIG. 3C is a perspective view of a scanning mechanism.

FIG. 4A is a diagram illustrating operation instruction information including a matrix type two-dimensional code, and FIG. 4B is a diagram illustrating operation instruction information indicated on a road surface in advance.

### DESCRIPTION OF EMBODIMENTS

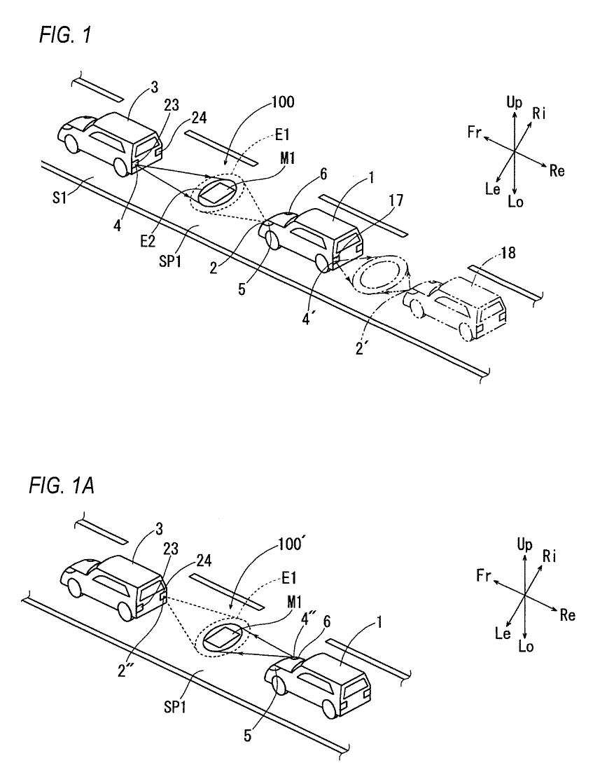

Hereinafter, embodiments of the present invention will be described with reference to FIG. 1 to FIGS. 4A and 4B. In each drawing, directions of each part of a vehicle headlamp and directions of a road viewed by a driver of a vehicle on which the vehicle headlamp is mounted is represented as follows: upper: lower: left: right: front: front: rear=Up: Lo: Le: Ri: Fr: Re.

An overall configuration of an automatic driving assist system 100 including a vehicle driving assist device 2 and an instruction display device 4 according to this embodiment will be described with reference to FIG. 1. Reference numeral 1 denotes a first vehicle in which the driving assist device 2 is mounted, and reference numeral 3 denotes a second vehicle in which the instruction display device 4 is mounted. The second vehicle 3 is traveling on the same lane S1 and precedes the first vehicle 1.

As shown in FIG. 1, the preceding second vehicle 3 displays an operation instruction information indication M1 by invisible light which is near-infrared light from the instruction display device 4 provided in a left-rear combination lamp 23, to a road surface near and behind the second vehicle 3. The operation instruction information indication M1 includes figures and characters in a predetermined form serving as operation instruction information for a following vehicle.

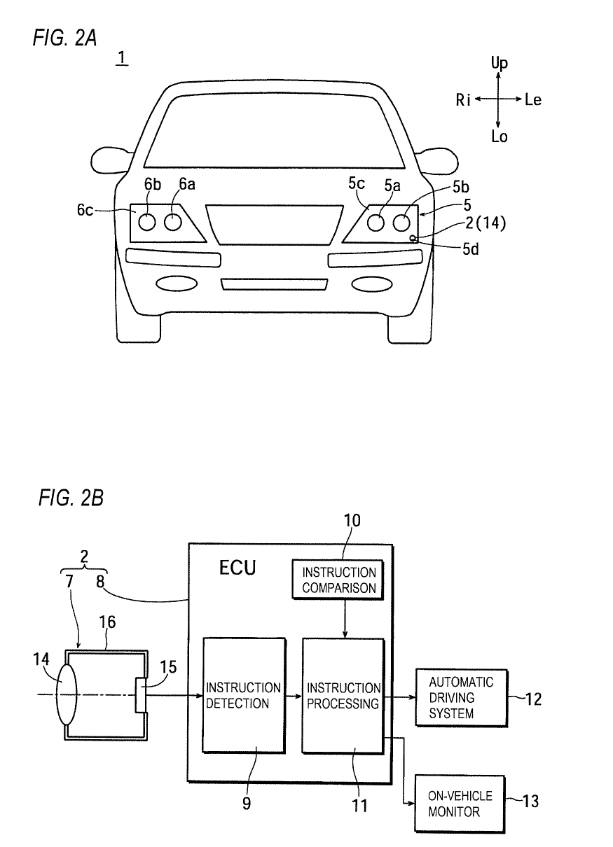

The driving assist device 2 of the following first vehicle 1 shown in FIG. 1 and FIGS. 2A and 2B includes an imaging device 7 which is an instruction recognition device and an ECU 8 serving as an operation control device. The imaging device 7 is provided to direct obliquely downward in a left headlamp 5 toward a road surface near and in front of the first vehicle 1, and takes an image of and recognizes figures and characters of the operation instruction information indication M1 displayed on the road surface in the front in an imaging range E1. The recognized operation instruction information is analyzed by the ECU 8 serving as an operation control device of the driving assist device 2 and sent to an automatic driving system 12 of the first vehicle 1, and the first vehicle 1 is automatically operated to follow the proceeding second vehicle 3.

The operation instruction information indication M1, which is displayed in an irradiation range E2 by the instruction display device 4 of the second vehicle 3 as shown in FIG. 1, is displayed on a road surface SP1 between the vicinity of the second vehicle 3 and the following first vehicle 1 in the lane S1. Therefore, the operation instruction information indication M1 is difficult to be recognized by a vehicle other than the first vehicle 1 which is the immediate following vehicle, so that it is less likely to erroneously operate an unexpected following vehicle including a driving assist device equivalent to that of the first vehicle 1. Further, since the imaging device 7 of the driving assist device 2 of the first vehicle 1 is directed obliquely downward toward the road surface near and in front of the first vehicle 1, the first vehicle 1 is less likely to erroneously recognize operation instruction information from an unexpected preceding vehicle other than the second vehicle 3 and can easily determine the second vehicle 3 which is the transmission source.

As a result, according to the automatic driving assist system 100 including the vehicle driving assist device 2 and the instruction display device 4, the system is easily configured such that interference from other unexpected vehicles is less likely to occur in operation instruction information exchanged between the first vehicle 1 and the second vehicle 3, and accurate automatic following operation of the second vehicle 3 following the preceding first vehicle 1 can be easily realized.

As shown in FIG. 1, in the first vehicle 1, an instruction display device 4′ with a configuration similar to that of the second vehicle 3 may be mounted in a rear combination lamp 17, in addition to the driving assist device 2 for following the second vehicle 3. In this case, according to the automatic driving assist system 100 of the present embodiment, another following vehicle 18 including a driving assist device 2′ similar to that of the first vehicle 1 can further follow the first vehicle 1, and two vehicles following the second vehicle 3 in series can perform automatic following driving. Further, according to the automatic driving assist system 100 of the present embodiment, by preparing two or more following vehicles with both the driving assist device similar to that of the first vehicle 1 and the instruction display device similar to that of the second vehicle, three or more vehicles following the second vehicle 3 in series can also perform automatic following driving.

In FIG. 1, the instruction display device 4, 4′ is mounted on the left combination lamp of the preceding vehicle 3, 1 and the driving assist device 2, 2′ is mounted on the left headlamp of the following vehicle 1, 18, but alternatively or in addition, as shown in FIG. 1A, a driving assist device 2″ similar to the driving assist device 2 may be mounted on a right-rear combination lamp 24 of the second vehicle 3 which is the preceding vehicle, and an instruction display device 4″ similar to the instruction display device 4 may be mounted on a right headlamp 6 of the first vehicle 1 which is the following vehicle.

The instruction display device 4″ of the first vehicle 1 shown in FIG. 1A is provided to direct obliquely downward toward a road surface in front of the vehicle and is configured to display the operation instruction information indication M1 on the road surface SPI between the first vehicle 1 and the second vehicle 3. An imaging device of the driving assist device vehicle 2″ of the second vehicle 3 is provided to direct obliquely downward toward a road surface behind the vehicle and is configured to take an image of and recognize figures or characters of the operation instruction information indication M1 in the imaging range E1. According to an automatic driving assist system 100′ including the vehicle driving assist device 2″ and the instruction display device 4″, the driving assist device 2″ of the preceding second vehicle 3 receives the operation instruction information from the first vehicle 1 which performs the automatic following driving so as to cause an on-vehicle monitor, a speaker or the like in the second vehicle 3 to operate to inform a driver of the second vehicle 3 of an automatic following driving state of the first vehicle 1 by characters, figures, sounds, or the like.

Next, the driving assist device 2 of the present embodiment will be described with reference to FIGS. 2A and 2B. The first vehicle 1 in FIG. 2A includes a left headlamp 5 including a high-beam headlamp unit 5a and a low-beam headlamp unit 5b, and a right headlamp 6 including a high-beam headlamp unit 6a and a low-beam headlamp unit 6b. The driving assist device 2 is provided behind a front lens 5c of the left headlamp 5.

The driving assist device 2 shown in FIG. 2B includes the imaging device 7 and the ECU 8 which is a control device. The ECU 8 includes an instruction detection unit 9, a Read Only Memory (ROM) 10 and an instruction processing unit 11 and is configured as an operation control device of the driving assist device. In the instruction processing unit 11, the automatic driving system 12 of the first vehicle 1 and an on-vehicle monitor 13 are connected. Since the driving assist device 2 is provided in the left headlight 5 together with the ECU 8 independent of the control of a main body of the first vehicle 1, it is advantageous that no extra load is applied to the control device which controls the operation of the main body of the first vehicle 1. The driving assist device 2, 2′ may be provided in the right headlamp 6, or may be provided at various parts directed to the front of the first vehicle 1, such as a front end central portion of a roof of the first vehicle 1. Further, the driving assist device 2″ may be provided in the left-rear combination lamp 23 of the second vehicle 3, or may be provided at various parts directed to the rear of the second vehicle 3, such as a rear end central portion of a roof of the second vehicle 3.

The imaging device 7 shown in FIG. 2B includes a transparent biconvex lens 14, an imaging element 15 and a holder 16. The biconvex lens 14 is fixed to the holder 16 together with the imaging element 15 in front of the imaging element 15. The front lens 5c of the left headlamp 5 shown in FIG. 2A includes a window portion 5d which is a through hole or a colorless transparent portion. The imaging device 7 is fixed to direct obliquely downward to the left headlight 5 such that the biconvex lens 14 is exposed forward from the window portion 5d and the biconvex lens 14 and the imaging element 15 are directed toward the road surface near and in front of the first vehicle 1.

As shown in FIG. 1, in the lane S1, when the operation instruction information indication M1 which is irradiated from the preceding second vehicle 3 and includes figures, characters and the like related to the operation instruction information on the road surface SP1 between the second vehicle 3 and the following first vehicle 1, is displayed with invisible light such as near-infrared light, the imaging device 7 of the driving assist device vehicle 2 of the first vehicle 1 forms an image of the invisible operation instruction information indication M1 on the imaging element 15 by the biconvex lens 14.

When the image of the operation instruction information indication M1 is formed on the imaging element 15, the ECU 8 detects occurrence of the operation instruction by the instruction detection unit 9. Then, the instruction processing unit 11 compares the image of the operation instruction information indication M1 with a specific operation instruction which is predetermined for each image stored in the ROM 10 and sends an operation instruction based on the taken image of the operation instruction information indication M1 to the automatic driving system 12. The automatic driving system 12 controls the first vehicle 1 to automatically operate regardless of the driving operation of the driver of the first vehicle 1 or to assist the driving operation, based on the operation instruction received from the driving assist device 2.

The ECU 8 shown in FIG. 2B performs control such that a predetermined indication is displayed on the on-vehicle monitor 13 via the instruction processing unit 11. The on-vehicle monitor 13 is configured to receive, for example, a control signal from the instruction processing unit 11 of the ECU 10 and display the state of the automatic driving operation with characters or figures which the driver can recognize, or display a message (such as exchange of sentences and greetings) emitted from the preceding second vehicle 3 by the driver or the like, with characters or the like. The driving assist device 2″ in FIG. 1A is configured to display a message which is related to the automatic following driving and is sent from the following first vehicle 1 (for example, a distance between the first vehicle 1 and the preceding second vehicle 3 is too large and the operation instruction information indication M1 from the second vehicle 3 within the image imaging range E1 cannot be recognized, and the automatic following driving cannot be performed) on the on-vehicle monitor 13 of the second vehicle 3 with characters or the like.

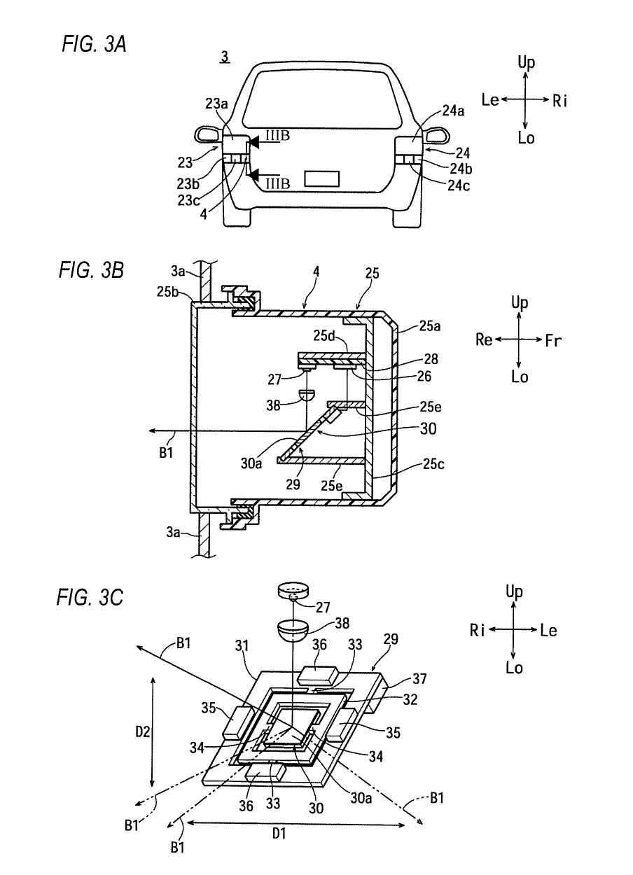

Next, the instruction display device 4 of the present embodiment will be described with reference to FIGS. 3A to 3C. The second vehicle 3 in FIG. 3A includes a left-rear combination lamp 23 and a right-rear combination lamp 24, the left and right combination lamps 23, 24 include tail and stop lamps 23a, 24a, turn signal lamps 23b, 24b, and backup lamps 23c, 24c, and the instruction display device 4 of the present embodiment is provided in the left-rear combination lamp 23.

The instruction display device 4 shown in FIG. 3B includes a base 25, an ECU 26 which is a control device, a light source 27 such as an LED which generates near-infrared light, a substrate 28, a scanning mechanism 29, and a condenser lens 38. The base 25 includes a body 25a, a rear cover 25b, and a metal support member 25c. In the body 25a formed of resin or the like, a rear opening is closed by the transparent rear cover 25b. The metal support member 25c includes a substrate fixing portion 25d and a scanning mechanism fixing portion 25e which protrude forward. An installation position of the instruction display device 4 is not limited to the left-rear combination lamp 23, and may be provided in the right-rear combination lamp 24, or at various portions directed to the front of the first vehicle 1, such as the rear end central portion of the roof or a rear window of the second vehicle 3.

As shown in FIG. 3B, the ECU 26 and the light source 27 are mounted on a substrate 28 and are electrically connected to an on-vehicle operation panel or the like (not shown) in the second vehicle 3. The substrate 28 is fixed to the substrate fixing portion 25d with the light source 27 facing downward. The scanning mechanism 29 is fixed to the scanning mechanism fixing portion 25e with a reflecting mirror 30 facing both the light source 27 and the rear cover 25b, and the condensing lens 38 which is a transparent plano-convex lens is fixed to the body 25a or the like so as to be positioned in an optical path between the light source 27 and the reflecting mirror 30. The instruction display device 4 is fixed to a vehicle body 3a of the second vehicle 3 such that the rear cover 25b is exposed rearward.

The scanning mechanism 29 shown in FIGS. 3B and 3C is configured by an MEMS mirror or the like and includes the reflecting mirror 30, a base 31, a rotation body 32, a pair of first torsion bars 33, a pair of second torsion bars 34, a pair of permanent magnets 35, a pair of permanent magnets 36 and a terminal 37. A reflecting surface 30a is formed by performing processing such as silver vapor deposition or plating on a front surface of the reflecting mirror 30. Further, the scanning mechanism 29 is supplied with power via a cable (not shown) connected to the terminal 37 and is connected to the ECU 26 to receive control.

The plate-shaped rotation body 32 in FIGS. 3B and 3C includes a first coil (not shown) which receives power from the terminal 37 and is supported on the base 31 to be tiltable to the left and right by the pair of first torsion bars 33. The reflecting mirror 30 includes a second coil (not shown) which receives power from the terminal 37 and is supported by the rotation body 32 to be tiltable upward and downward by the pair of second torsion bars 34.

The rotation body 32 shown in FIG. 3C is swing-rotated reciprocally at a high speed in a left-right direction (direction D1) around an axis of the first torsion bar 33 by the first coil that is energized and controlled by the pair of permanent magnets 35 and a control mechanism (not shown) so as to tilt the reflecting mirror 30 to the left and right at a high speed. The reflecting mirror 30 is swing-rotated reciprocally at a high speed in an upper-lower direction (direction D2) around an axis of the second torsion bar 34 by the second coil that is energized and controlled by the pair of permanent magnets 36 and a control mechanism (not shown).

The ECU 26 in FIG. 3B is connected to an operation panel (not shown) provided in an interior of the second vehicle 3 and is configured to turn on/off the light source 27 at a predetermined timing and scan the reflecting mirror 30, which receives light B1 from the light source 27, in the upper-lower direction (direction D1) and the left-right direction (direction D2). The light B1 passes through the rear cover 25b and is irradiated on the road surface behind the second vehicle 3. The instruction display device 4 displays characters or figures of predetermined shape including a combination of dots or lines on the road surface behind the second vehicle 3 based on the operation to the operation panel (not shown) by the driver. For example, when the driver presses a following driving button displayed on the operation panel, the instruction display device 4 is configured to display an operation instruction information indication M1 with invisible light which causes the following vehicle to follow the second vehicle 3 at a predetermined position away from the second vehicle 3, on the road surface behind the second vehicle 3. Then, the driving assist device 2 of the first vehicle 1 shown in FIG. 1 and FIG. 2B sends the operation instruction based on the operation instruction information indication M1 to the automatic driving system 12 so as to control the first vehicle 1 to automatically follow the second vehicle 3 in a predetermined manner.

The instruction display device 4 displays the operation instruction information indication M1 on the road surface with invisible light which is near-infrared light. Therefore, even in a case where the instruction display device 4 and a road surface drawing device which draws (displays) a notation indication with visible light to a pedestrian or a driver of the vehicle, are both mounted to a vehicle, it is advantageous that the pedestrian or the like has no difficulty in reading even when the operation instruction information indication M1 is drawn (displayed) on the road surface.

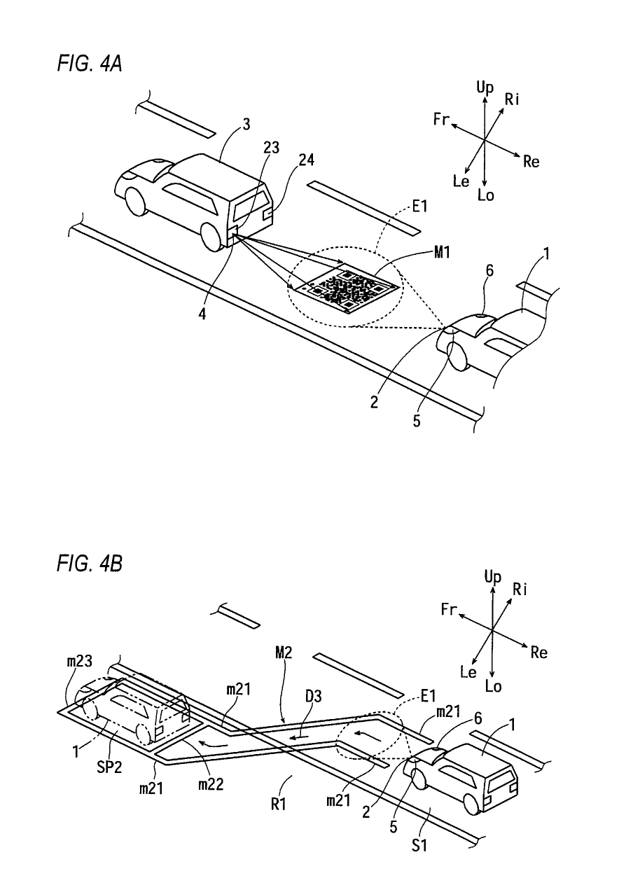

As shown in FIG. 4A, the instruction display device 4 of the second vehicle 3 displays, for example, the operation instruction information indication M1 as a matrix-type two-dimensional code, a stack type two-dimensional code, or the like with invisible light, and the driving assist device 2 of the first vehicle 1 obtains operation instruction information from an analysis result of an image of the two-dimensional code taken by the imaging device 7. The operation instruction information indication M1 is not limited to the two-dimensional code, and may be expressed in various manners such as a bar codes or characters.

As shown in FIG. 4B, the operation instruction information indication is not limited to the optical representation displayed by invisible light from the instruction display device of the preceding vehicle, and may be a graphic indication which is provided in advance as a line, a marker, a character, a figure, a pattern, or the like by a road stud, paint, a stone, or the like on the road surface in advance. The operation instruction information indication M2 shown in FIG. 4B is a guide and stop symbol for parking in a frame of a parking space SP2 provided on a shoulder R1 of the lane S1.

For example, the operation instruction information indication M2 shown in FIG. 4B includes a pair of parallel guide lines m21 formed with a predetermined width and a predetermined color, a deceleration line m22 which goes straight perpendicular to the middle of the pair of guide lines and indicates a place approaching a predetermined parking space, and a stop line m23 which goes straight perpendicular at the end of the guide lines m21.

For example, when the driving assist device 2 of the first vehicle 1 detects the guide line m21 in the imaging range E1 with the imaging device 7, an instruction to travel so as not to travel over from the inside of the pair of guide lines m21 is sent to the automatic driving system 12 in FIG. 2B, and the first vehicle 1 automatically travels inside the pair of guide lines m21. Since the vehicle approaches the predetermined parking space SP2 when the deceleration line m22 is detected by the imaging device 7, the driving assist device 2 sends a slow down operation instruction causing the vehicle to decelerate to a speed at which the vehicle can be stopped at any time to the automatic driving system 12 and the first vehicle 1 automatically performs slowing driving inside the pair of guide lines m21. Since the driving assist device 2 is within the predetermined parking space SP2 when the stop line m23 formed at the end of the guide lines m21 is detected by the imaging device 7, the driving assist device 2 sends a stop instruction to the automatic driving system 12 and the first vehicle 1 automatically stops without running over from the frame of the parking space SP2.

In a case where such an operation instruction information indication M2 is provided from the lane S1 on which the vehicle travels to the parking space SP2 on the road shoulder RI, even if the driver of the first vehicle 1 is not good at parking, the first vehicle 1 can be automatically parked by the driving assist device 2 at an optimum position without straying out from the parking space SP2. Further, since a plurality of vehicles including the driving assist devices 2 are automatically parked in optimum positions without straying out from the parking spaces SP2, an provider of the parking lot does not need to set an extra margin for each area of the parking space in order to avoid collision between a vehicle and an adjacent vehicle which are prevented to deviate from the optimum position. Since the driving assist device 2 can accurately park a plurality of vehicles including the driving assist devices 2 in extremely narrow spaces between vehicles, space saving of the parking space can be achieved.

1. A vehicle driving assist device which is mounted on a vehicle, comprising:
an instruction recognition device which is configured to recognize operation instruction information for a vehicle displayed on a road surface,
wherein the vehicle on which the vehicle driving assist device is mounted is operated based on the operation instruction information.

2. An instruction display device which is mounted on a vehicle and is configured to display operation instruction information for another vehicle on a road surface with near-infrared light.

3. The instruction display device according to claim 2, which is configured to display the operation instruction information on the road surface between the vehicle and another vehicle which includes a driving assist device having an instruction recognition device configured to recognize operation instruction information.

4. The instruction display device according to claim 2,
wherein the vehicle on which the instruction display device is mounted includes a driving assist device having an instruction recognition device configured to recognize operation instruction information.

5. The vehicle driving assist device according to claim 1,
wherein the operation instruction information is a graphic indication formed on a road surface in advance.

6. A vehicle lamp comprising the vehicle driving assist device according to claim 1.

7. A vehicle lamp comprising the instruction display device according to claim 2.
